(19) United States
(12) Patent Application Publication
(10) Pub. No.: US 2014/0096660 A1
(43) Pub. Date: Apr. 10, 2014

(54) SUGAR CANE KNIFE

(71) Applicant: FISHER BARTON SPECIALTY PRODUCTS, INC., Watertown, WI (US)

(72) Inventor: Darrel Lee Turner, Reeseville, WI (US)

(73) Assignee: FISHER BARTON SPECIALTY PRODUCTS, INC., Watertown, WI (US)

(21) Appl. No.: 13/784,148

(22) Filed: Mar. 4, 2013

Related U.S. Application Data
(60) Provisional application No. 61/709,638, filed on Oct. 4, 2012.

(51) Int. Cl. C13B 5/08

(52) U.S. Cl. CPC C13B 5/08
USPC 83/651; 76/101.1

(57) ABSTRACT

A knife includes a knife body defining a longitudinal axis. The knife body includes a support portion and a beveled blade portion extending from the support portion. The beveled blade portion includes two end regions in a direction of the longitudinal axis and an intermediate region positioned between the end regions. The end regions have a first hardness, and the intermediate region has a second hardness. The second hardness is greater than the first hardness. The end regions of the beveled blade portion are configured to preferentially wear relative to the intermediate region.

### CROSS-REFERENCE TO RELATED APPLICATIONS

This application claims the benefit of U.S. Provisional Application No. 61/709,638, filed Oct. 4, 2012. The entire content of the foregoing application is hereby incorporated by reference.

### BACKGROUND

For harvesting sugar cane stems, a sugar cane chopper is typically used. Sugar cane stalks can measure approximately 1 meter to approximately 6 meters in height and approximately 3 centimeters (cm) to approximately 5 cm in diameter, and carry bulky leafy material. A sugar cane chopper cuts whole cane stems at a base, tears or removes leafy trash material from the stalks, and chops the stems into a number of small sections or short pieces called billets. To this end, the sugar cane chopper uses hydraulically driven rotary knives. Referring to FIG. 1, in operation, two beveled knives 10, 20, (an upper knife 10 and a lower knife 20), work together. The upper and lower knives 10, 20 are each mounted on respective drums 30, 40. The drums 30, 40 rotate, thereby moving the upper and lower knives 10, 20 toward each other in a mating relationship, to pinch and cut whole cane stems (not shown) into billets.

Referring also to FIGS. 2, 3a, and 3b, in use, one or both of the upper and lower knives 10, 20 may wear at a mid-section 50, forming a concave wear arc 60, and thereby forming a knife gap G between the upper and lower knives 10, 20 when the knives 10, 20 are moved toward each other. The knives 10, 20 define a longitudinal axis 160, and the concave wear arc 60 is recessed when viewed in a direction substantially perpendicular to the longitudinal axis 160 (see FIG. 2) and also when viewed in a direction of the longitudinal axis 160 (see FIGS. 3a and 3b). Referring to FIG. 3a, each knife 10, 20 includes a knife body 12 including a support portion 14 and a beveled blade portion 16. The beveled blade portion 16 includes a cutting edge 18 and a beveled or angled surface 19. At less worn portions 70 adjacent the ends of knives 10, 20, the concave wear arc 60 forms a slightly arcuate wear surface that is recessed from the initial or original beveled surface 19 (shown as a dashed line). Thus, when viewed in a direction of the longitudinal axis 160, the portion between wear arc 60 and dashed lined 19 is removed via wearing or worn way over time from the beveled blade portion 16. Referring to FIG. 3b, at the mid-section 50, the cutting edge 18 recedes from its initial position (i.e., to the left in FIG. 3b), and the concave wear arc 60 forms a more pronounced arcuate wear surface that is recessed from the initial beveled surface 19. Like in FIG. 3a, when viewed in a direction of the longitudinal axis 160, the portion between wear arc 60 and dashed line 19 in FIG. 3b is removed via wearing from the beveled blade portion 16. The removed portions between the wear arc 60 and dashed line 19 in FIGS. 3a and 3b form the knife gap G when the knives 10, 20 are moved toward each other.

The knife gap G is most pronounced at the mid-section 50 of the respective knife 10, 20, and may allow cane leaves to pass through without getting cut. Therefore, if the knife gap G becomes too large, some sugar cane choppers allow one or both of the upper and lower knives 10, 20 to be adjusted to move one knife closer to the other. However, if the knives 10, 20 are moved too close to each other, the knives 10, 20 may contact each other at less worn portions 70 on the ends, thereby generating undesirable noise and vibration in use, which may loosen mechanical parts. Accordingly, if the concave wear arc 60 forms on at least one of the upper and lower knives 10, 20, it can be hard to bring the knives 10, 20 close enough to each other while avoiding undesirable contact between less worn portions 70 of the knives 10, 20. Because the arc 60 is recessed relative to adjacent less worn portions 70 of the respective knife 10, 20, even if the adjacent less worn portions 70 of the upper and lower knives 10, 20 are moved closely together, the recessed area would still leave the gap G between the knives 10, 20 (i.e., relative motion together would be limited by the less worn portions 70). Thus, if the concave wear arc 60 forms, the knife 10, 20 may become unusable or potentially damage the sugar cane chopper.

### SUMMARY

The present invention provides a sugar cane knife that can retard or reduce a concave wear arc formation in use, thereby potentially leading to a longer service life.

In one aspect, the invention provides a knife, which includes a knife body defining a longitudinal axis. The knife body includes a support portion and a beveled blade portion extending from the support portion. The beveled blade portion includes two end regions in a direction of the longitudinal axis and an intermediate region positioned between the end regions. The end regions have a first hardness, and the intermediate region has a second hardness. The second hardness is greater than the first hardness. The end regions of the beveled blade portion are configured to preferentially wear relative to the intermediate region.

In another aspect, the invention provides a method of producing a knife, which includes providing a knife body that defines a longitudinal axis. The knife body includes a support portion and a beveled blade portion extending from the support portion. The beveled blade portion includes two end regions in a direction of the longitudinal axis and an intermediate region positioned between the end regions. The beveled blade portion can be hardened relative to the support portion. The end regions of the beveled blade portion are configured to preferentially wear relative to the intermediate region. Configuring the end regions can include selectively softening the end regions.

Other aspects of the invention will become apparent by consideration of the detailed description and accompanying drawings.

### BRIEF DESCRIPTION OF THE DRAWINGS

FIG. 1 is a side view of a sugar cane chopper blade assembly, illustrating knives mounted on drums.

FIG. 2 is a plan view of one of the knives of FIG. 1.

FIG. 3a is a schematic end view of the knife taken along line 3a-3a of FIG. 2.

FIG. 3b is a schematic cross-sectional view of the knife taken along line 3b-3b of FIG. 2.

FIG. 4 is a plan view of a knife embodying the invention and for use in sugar cane harvesting.

FIG. 5 is a cross-sectional view of the knife of FIG. 4.

FIG. 6 is a cross-sectional view of a knife according to another embodiment of the invention.

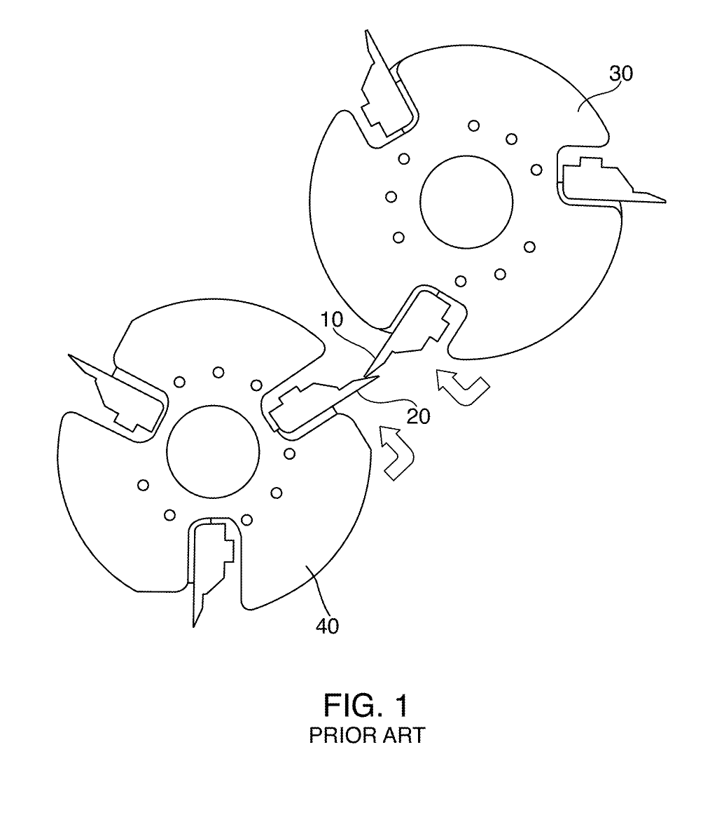

It should be understood that the invention is not limited in its application to the details of construction and the arrangements of the components set forth in the following description or illustrated in the above-described drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

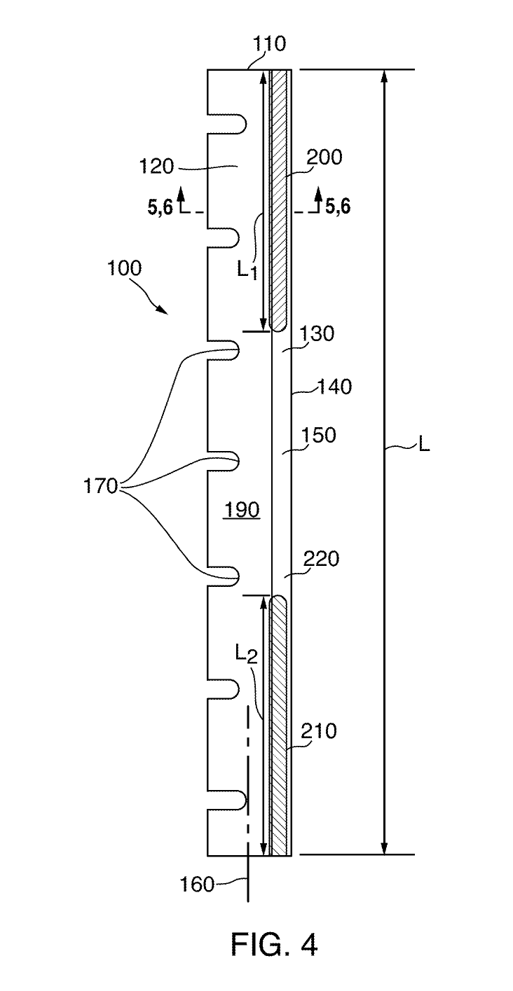

FIG. 4 is a plan view of a knife 100 embodying the invention and for use in sugar cane harvesting. The knife 100 includes a knife body 110 including a support portion 120 and a beveled blade portion 130. The beveled blade portion 130 includes a cutting edge 140 and a beveled or angled surface 150. Although FIG. 4 illustrates the knife body 110 as including a single beveled surface 150, in other constructions, the knife body may include two beveled surfaces 150 that give the appearance of a V shape in cross section. The illustrated knife body 110 defines a longitudinal axis 160. In some constructions, the two angled surfaces 150 may be substantially symmetrical from a view in a direction of the longitudinal axis 160. In other constructions, however, the two angled surfaces 150 may be substantially asymmetrical from a view in the direction of the longitudinal axis 160.

In operation, at least two knives 100 are each mounted on a respective drum (not shown), and are rotatably driven toward each other. That is, an upper knife and a lower knife are moved toward each other in a mating relationship, to pinch and cut whole cane stems (not shown) into billets. In this regard, the lower knife may resemble and operate like an anvil. As used herein, the terms “upper,” “lower,” “top,” “bottom,” “front,” “rear,” “side,” and other directional terms are not intended to require any particular orientation, but are instead used for purposes of description only. Moreover, for the purposes of the description, the configuration of the upper and lower knives 100 can be generally the same, and will be described with reference to the lower knife with the same effect as to the upper knife. Configuring the upper and lower knives 100 to be generally the same can be easier for manufacturing as well as for installation. The knife body 110 can be stamped or pressed from a boron steel, such as the steels having the designations 10B36, 10B37, 10B38, 10B39, 10B40, 10B41, and 10B42. In other constructions, the knife body 110 can be made in other manners from other materials.

In the illustrated construction, the support portion 120 includes U-shaped cutouts 170 positioned away from the beveled blade portion 130. The U-shaped cutouts 170 can be utilized for mounting the knife 100 on a drum (not shown), so that the knife 100 can be rotatably driven for harvesting sugar cane stems. Furthermore, the U-shaped cutouts 170 can be utilized to adjust or move a pair of knives 100 closer to each other in a sugar cane chopper blade assembly. Although FIG. 4 illustrates seven U-shaped cutouts 170 positioned on the support portion 120, it is to be appreciated that other constructions may utilize other numbers of U-shaped cutouts 170. In still other constructions, one or more knives 100 may be mounted or coupled to the drum using other suitable mechanisms that may not require the U-shaped cutouts 170.

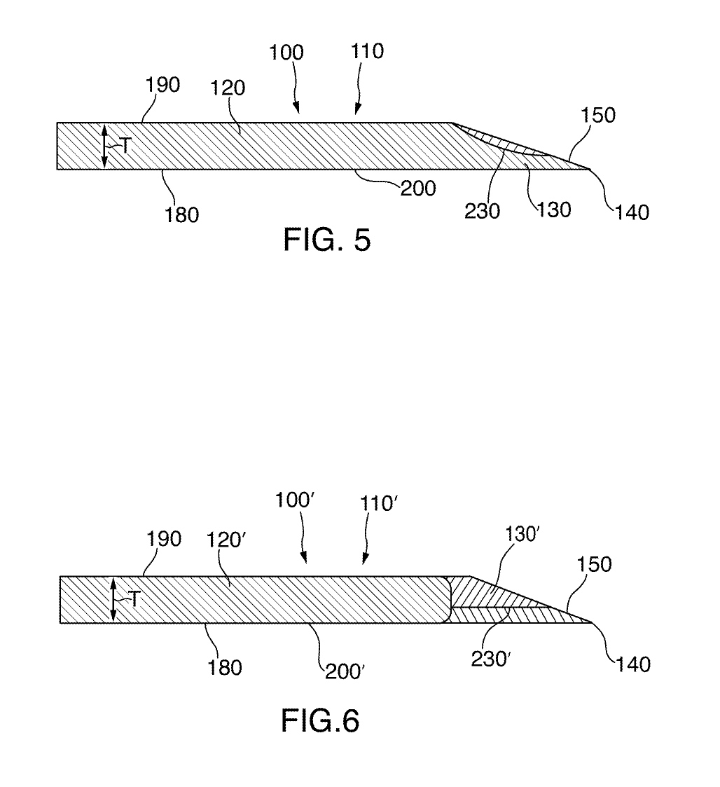

Referring also to FIG. 5, the support portion 120 includes a first surface 180 including the cutting edge 140 and a second surface 190 extending substantially parallel to the first surface 180, defining a blade thickness T therebetween. The first and second surfaces 180, 190 are each intersected by the beveled surface 150. The beveled surface 150 extends at an acute angle from the first surface 180 and an obtuse angle from the second surface 190, such that the cross section of the beveled blade portion 130 tapers gradually in thickness in a direction substantially perpendicular to the longitudinal axis 160. In the illustrated construction, the beveled surface 150 is substantially linear when viewed in a direction of the longitudinal axis 160. In other constructions, however, the beveled surface 150 can include one or more arcuate portions when viewed in a direction of the longitudinal axis 160.

The illustrated beveled blade portion 130 includes two end regions 200, 210 in a direction of the longitudinal axis 160, and an intermediate region 220 positioned between the end regions 200, 210. The end regions 200, 210 of the beveled blade portion 130 can be configured to preferentially wear or abrade relative to the intermediate region 220. To this end, the hardness of the end regions 200, 210 is configured to be less than the hardness of the intermediate region 220. In the illustrated construction, portions of the end regions that are softened for preferential wearing are confined to the beveled blade portion 130 and do not extend to the support portion 120.

In some constructions, each of the end regions 200, 210 has a hardness of less than or equal to approximately 30 in Rockwell C-scale hardness. Moreover, in some constructions, the end regions 200, 210 have substantially the same hardness. In other constructions, however, the hardness of one end region may be different from the hardness of the other end region. In still other constructions, each end region 200, 210 may have a hardness that is greater than 30 in Rockwell C-scale hardness, so long as the hardness of the end region 200, 210 is less than the hardness of the intermediate region 220. In some constructions, the intermediate region 220 has a hardness of approximately 46 to approximately 55 in Rockwell C-scale hardness. In other constructions, however, the intermediate region 220 may have a hardness of other values. In some constructions, at least one of the end regions 200, 210 has a predominantly pearlitic microstructure (a higher temperature transformation product), and the intermediate region 220 has a predominantly martensitic microstructure (formed by diffusionless phase transformation in which the parent and product phases have a specific crystallographic relationship), or a bainitic microstructure (formed above the martensite start temperature). In other constructions, however, the end regions 200, 210 and the intermediate region 220 may be formed of other microstructures.

The end regions 200, 210 are configured to retard or reduce a concave wear arc formation in use, thereby potentially leading to a longer service life. Referring again to FIG. 4, the illustrated knife body 110 has a knife length L in the direction of the longitudinal axis 160. In one configuration, the knife length L is approximately 85 cm. In other constructions, however, the knife length L may be of any other length so long as it is suitable for sugar cane harvesting. Moreover, although FIG. 4 illustrates the knife 100 as including a single knife body 110, in other constructions the knife 100 can be made up of a plurality of knife bodies 110. Each of the end regions 200, 210 has a respective end region length L₁ and L₂. In some constructions, each end region length L₁, L₂ is approximately 5% to approximately 45% of the knife length L. Although FIG. 4 illustrates the end region lengths L₁, L₂ as being substantially the same, in other constructions, the end region lengths L₁ and L₂ may be different from each other. In further constructions, each end region length L₁, L₂ is approximately 30% to approximately 40% of the knife length L. In one configuration, each end region length L₁, L₂ is approximately one-third of the knife length L. In other constructions, the end region length L₁, L₂ may be of other ratios relative to the knife length L, so long as the respective end regions 200, 210 assist in retarding or reducing the concave wear arc formation in use.

Referring again to FIG. 5, each illustrated end region 200, 210 is spaced apart from the cutting edge 140 and extends along at least a portion of the beveled surface 150. For the purposes of the description, the configuration of the end regions 200, 210 can be generally the same, and will be described with reference to the end region 200 with the same effect as to the end region 210. In the illustrated construction, the end region 200 encompasses approximately 60% to approximately 75% of the blade thickness T and defines an interface 230 positioned between the first and second surfaces 180, 190. In one configuration, the blade thickness T is approximately 0.8 cm, and the end region 200, 210 measures approximately 0.6 cm in a direction of the blade thickness T. The illustrated interface 230 gives the appearance of a crescent or arcuate shape in cross section. In other constructions, however, the interface 230 may assume any geometric form, including, but not limited to, a regular polyhedral and an irregular polyhedral shape, derivatives thereof, and combinations thereof.

According to one aspect, a method of producing a knife for sugar cane harvesting generally includes providing the knife body or blank 110, including the support portion 120 and the beveled blade portion 130, and austempering the knife body 110 to a hardness of approximately 46 to approximately 55 in Rockwell C-scale hardness. As used herein, austempering refers to the isothermal transformation of a ferrous alloy at a temperature below that of pearlite formation and above that of martensite formation. For austempering, the knife body 110 may be heated to a temperature within the austenizing range, usually approximately 790° C. to approximately 915° C., quenched in a bath maintained at a constant temperature, usually in the range of approximately 260° C. to approximately 400° C., allowed to transform isothermally to bainite in this bath, and, cooled to room temperature. In other constructions, however, the knife body 110 may be provided using other heat treatments. For example, the knife body 110 may be allowed to form a predominantly martensitic microstructure. The knife body 110 may subsequently be machined to form the beveled blade portion 130.

The end regions 200, 210 of the beveled blade portion 130 are configured to preferentially wear relative to the intermediate region 220. To this end, the end regions 200, 210 can be selectively softened. For example, the end regions 200, 210 may be induction-heated or induction-scanned at a suitable temperature to transform the end regions 200, 210 to a pearlitic microstructure, while the intermediate region 220 is shielded from the heat treatment so that the intermediate region remains in a predominantly bainitic or martensitic microstructure. As a result, the end regions 200, 210 may be selectively softened to a hardness of less than or equal to approximately 30 in Rockwell C-scale hardness, while the intermediate region 220 retains a hardness of approximately 46 to approximately 55 in Rockwell C-scale hardness.

FIG. 6 illustrates a knife 100′ according to another embodiment of the invention. The beveled blade portion 130′ in this embodiment is hardened relative to the support portion 120′. In some constructions, the beveled blade portion 130′ is induction-scanned and quenched, while the end regions 200′, 210′ are shielded from the quenching so as to remain in a pearlitic microstructure. As a result, the end regions 200′, 210′ may be selectively softened to a hardness of less than or equal to approximately 30 in Rockwell C-scale hardness, while the intermediate region 220 achieves a hardness of approximately 48 to approximately 55 in Rockwell C-scale hardness. In other constructions, however, the beveled blade portion 130′ may be subjected to any other heat treatment that suitably hardens the beveled blade portion 130′ relative to the support portion 120′, while shielding the end regions 200′, 210′ so that they are selectively softened.

In the illustrated construction, the interface 230′ is positioned between the first and second surfaces 180, 190 and substantially parallel to the first and second surfaces 180, 190. In other constructions, however, the interface 230′ may include one or more arcuate portions in cross section. Depending on the usage requirements or preferences for the particular knife 100′, the hardness may be decreasing or dropping abruptly or in a steep manner from the hardened beveled blade portion 130′ to the end regions 200′, 210′, rather than decreasing or dropping gradually or continuously. In one configuration, the knife 100′ has a first hardness in the end regions 200′, 210′, and a second hardness in the remainder of the hardened beveled blade portion 130′, without having an intermediate hardness value therebetween.

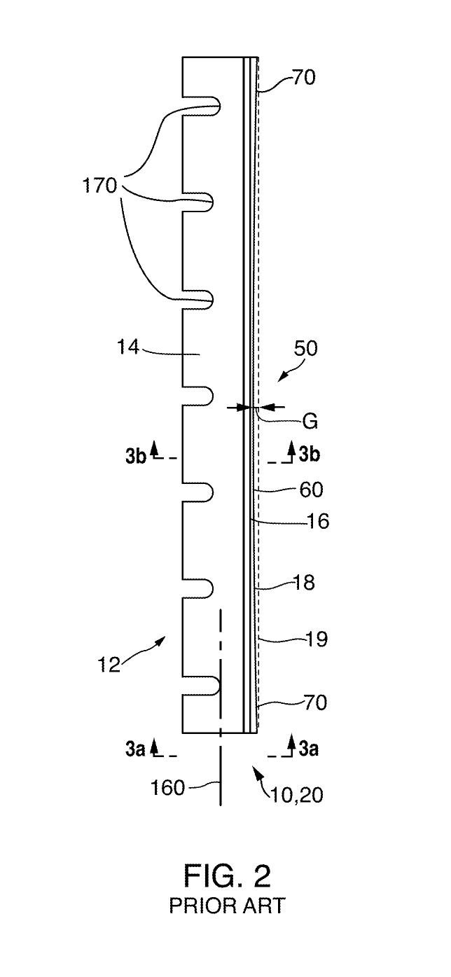

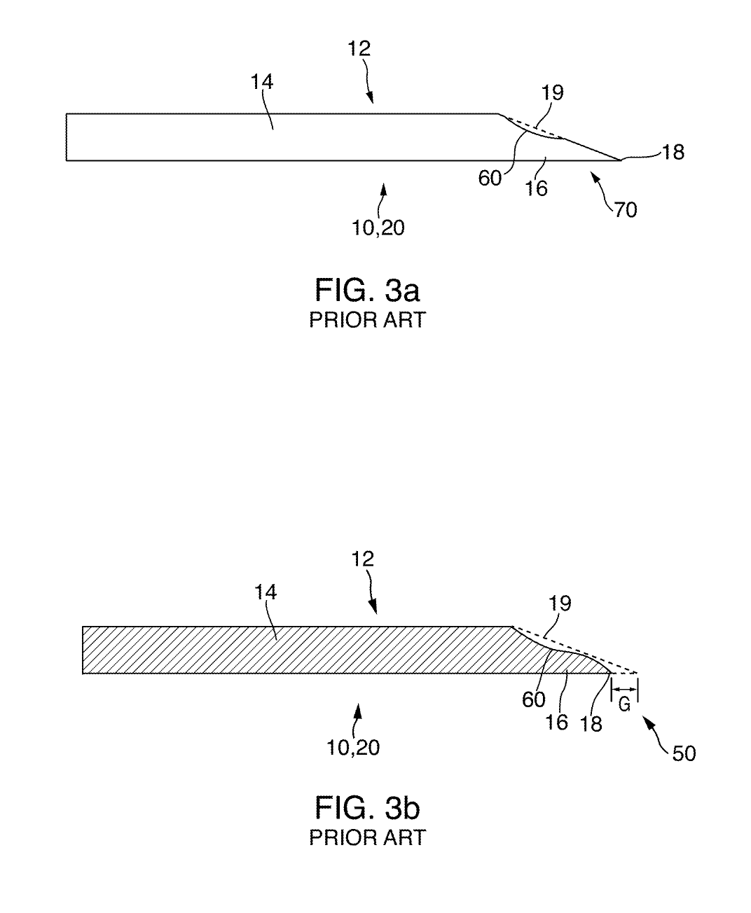

In operation, at least two of the knives 100, 100′ are mounted on a respective drum (not shown), and rotatably driven toward each other. That is, an upper knife and a lower knife are moved toward each other in a mating relationship, and the lower knife resembles and operates like an anvil. The lower knife in particular may be subject to wear; however, the knives 100, 100′ disclosed herein can retard or reduce a concave wear arc formation in use. As described above, the disclosed lower knife 100, 100′ are configured to preferentially wear in the respective end regions 200, 210, 200′, 210′ relative to the respective intermediate region 220. That is, the end regions 200, 210, 200′, 210′ are more easily wearable compared to the intermediate region 220 so as to speed up the wear at the end regions 200, 210, 200′, 210′. Thus, rather than forming a pronounced concave wear arc 60 as illustrated in FIGS. 2, 3a, and 3b, the knife 100, 100′ promotes a more even wear, thereby maintaining a substantially uniform clearance between the upper and lower knives. If the clearance between the upper and lower knives becomes too large due to wear, the knives 100, 100′ can be adjusted to move the knives closer to each other. Although the end regions 200, 210, 200′, 210′ are selectively softened, the cutting edge 140 of the knife 100, 100′ is configured to retain its hardness. The disclosed knives can be used in applications including, but not limited to, a sugar cane chopper for harvesting sugar cane stems. The knives would also be useful for numerous other applications wherein a concave wear arc may otherwise form, including, but not limited to, agricultural crop chopping or harvesting machines, recycling machines, and lawn mowers.

It is understood that the invention may embody other specific forms without departing from the spirit or central characteristics thereof The disclosure of aspects and embodiments, therefore, are to be considered as illustrative and not restrictive. While specific embodiments have been illustrated and described, other modifications may be made without significantly departing from the spirit of the invention. Various features of the invention are set forth in the following claims.

1. A knife comprising:
a knife body defining a longitudinal axis, the knife body including
a support portion and
a beveled blade portion extending from the support portion, and the beveled blade portion including two end regions in a direction of the longitudinal axis and an intermediate region positioned between the end regions, wherein the end regions have a first hardness, wherein the intermediate region has a second hardness, and wherein the second hardness is greater than the first hardness.

2. A knife as set forth in claim 1, wherein the end regions of the beveled blade portion are configured to preferentially wear relative to the intermediate region.

3. A knife as set forth in claim 1, wherein the knife has a knife length in the direction of the longitudinal axis, wherein each of the end regions has a respective end region length, and wherein each end region length is approximately 5% to approximately 45% of the knife length.

4. A knife as set forth in claim 3, wherein each end region length is approximately 30% to approximately 40% of the knife length.

5. A knife as set forth in claim 1, wherein the beveled blade portion includes a cutting edge and a beveled surface, and each end region is spaced apart from the cutting edge and extends along at least a portion of the beveled surface.

6. A knife as set forth in claim 5, wherein the support portion includes a first surface including the cutting edge and a second surface extending substantially parallel to the first surface, defining a blade thickness therebetween, wherein each end region encompasses approximately 60% to approximately 75% of the blade thickness and defines an interface positioned between the first and second surfaces.

7. A knife as set forth in claim 1, wherein the support portion has a hardness of approximately 46 to approximately 55 in Rockwell C-scale hardness.

8. A knife as set forth in claim 1, wherein the second hardness is greater than a hardness of the support portion.

9. A knife as set forth in claim 1, wherein the first hardness is less than or equal to approximately 30 in Rockwell C-scale hardness.

10. A knife as set forth in claim 1, wherein at least one of the end regions has a predominantly pearlitic microstructure, and wherein the intermediate region has a predominantly martensitic or bainitic microstructure.

11. A method of producing a knife, the method comprising:
providing a knife body, the knife body defining a longitudinal axis, the knife body including
a support portion and
a beveled blade portion extending from the support portion, and the beveled blade portion including two end regions in a direction of the longitudinal axis and an intermediate region positioned between the end regions; and
configuring the end regions to preferentially wear relative to the intermediate region.

12. A method as set forth in claim 11, wherein the knife has a knife length in the direction of the longitudinal axis, wherein each of the end regions has a respective end region length, and wherein each end region length is approximately 5% to approximately 45% of the knife length.

13. A method as set forth in claim 12, wherein each end region length is approximately 30% to approximately 40% of the knife length.

14. A method as set forth in claim 11, wherein the beveled blade portion includes a cutting edge and a beveled surface, and each end region is spaced apart from the cutting edge and extends along at least a portion of the beveled surface, wherein the support portion includes a first surface including the cutting edge and a second surface extending substantially parallel to the first surface, defining a blade thickness therebetween, and wherein each end region encompasses approximately 60% to approximately 75% of the blade thickness and defines an interface positioned between the first and second surfaces.

15. A method as set forth in claim 11, wherein providing the knife body includes austempering the knife body to a hardness of approximately 46 to approximately 55 in Rockwell C-scale hardness.

16. A method as set forth in claim 15, wherein configuring the end regions includes softening the end regions.

17. A method as set forth in claim 11, further comprising hardening the beveled blade portion relative to the support portion.

18. A method as set forth in claim 17, wherein configuring the end regions includes softening the end regions.

19. A method as set forth in claim 17, wherein hardening the beveled blade portion includes induction scanning and quenching the beveled blade portion to a hardness of approximately 48 to approximately 55 in Rockwell C-scale hardness.

20. A method as set forth in claim 11, wherein configuring the end regions includes softening the end regions to a hardness of less than or equal to approximately 30 in Rockwell C-scale hardness.
